(19) United States
(12) Patent Application Publication
(10) Pub. No.: US 2006/0194610 A1
(43) Pub. Date: Aug. 31, 2006

(54) Band selection methods and related devices in a mobile communication system

(75) Inventor: Yu-Li Su, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/354,315

(22) Filed: Feb. 14, 2006

Related U.S. Application Data
(60) Provisional application No. 60/656,243, filed on Feb. 25, 2005.

(51) Int. Cl. H04M 1/00; H04Q 7/20

(52) U.S. Cl. 455/552.1; 455/435.2

(57) ABSTRACT

A band selection method is utilized in a mobile station. The mobile station operates in a plurality of supported bands in a mobile communication system. The mobile communication system comprises a plurality of cells. The method comprises: calculating a suggested value of band selection to match a current environmental state of a mobile communication system; changing a setting of band selection according to the suggested value of band selection; camping on a cell according to the setting of band selection.

### CROSS REFERENCE TO RELATED APPILCATIONS

This application is co-pended and related with U.S. patent application Ser. No. 11/159,849, filed Jun. 23, 2005 and entitled “A METHOD FOR CARRIER SEARCH FOR A MOBILE COMMUNICATION SYSTEM”, and U.S. patent application filed Dec. 28, 2005 and entitled “MODE SELECTION METHODS AND RELATED DEVICES IN A MOBILE COMMUNICATION SYSTEM”.

### BACKGROUND OF THE INVENTION

1. Field of the Invention

The present invention relates to band selection methods, and in particular relates to band selection methods in a mobile communication system.

2. Description of the Related Art

A multi-band mobile station (e.g. mobile telephone) can operate in all supported bands (e.g. 850, 900, 1800, 1900). When searching for a network or selecting a cell, the mobile station searches all RF channels within the bands of operation (subset of the supported bands). This, however, consumes extra power when there are unavailable bands in bands of operation. Additionally, unexpected failure may occur if some available bands are excluded from bands of operation.

### BRIEF SUMMARY OF THE INVENTION

A detailed description is given in the following embodiments with reference to the accompanying drawings.

A band selection method utilized in a mobile station is provided. The mobile station operates properly on a plurality of supported bands in a mobile communication system. The mobile communication system comprises a plurality of cells. The method comprises: calculating a suggested value of band selection to match a current environmental state of the mobile communication system; changing a setting of band selection according to the suggested value of band selection; and camping on a cell according to the setting of band selection.

### BRIEF DESCRIPTION OF THE DRAWINGS

The present invention can be more fully understood by reading the subsequent detailed description and examples with references made to the accompanying drawings, wherein:

FIG. 1 is a flowchart illustrating a band selection method according to a first embodiment of the invention;

FIG. 2 is a flowchart illustrating a band selection method according to a second embodiment of the invention;

FIG. 3A is a flowchart illustrating a band selection method according to a third embodiment of the invention;

FIG. 3B is a flowchart illustrating the improved recovery procedure;

FIG. 4 is a flowchart illustrating a band selection method according to a fourth embodiment of the invention;

FIG. 5 is a flowchart illustrating a band selection method according to a fifth embodiment of the invention;

FIG. 6 is a flowchart illustrating a band selection method according to a sixth embodiment of the invention;

FIG. 7 is a flowchart illustrating a band selection method according to a seventh embodiment of the invention;

FIG. 8A and FIG. 8B show different item formats in the look-up table;

FIG. 9 is a flowchart illustrating a band selection method according to an eighth embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Some band selection methods are utilized in the mobile station to dynamically change a setting of band selection (e.g. preferred bands) in the mobile station to solve the above-mentioned problems. Preferred bands are the bands selected by a user, and bands of operation are the overlapping part of the supported bands and the preferred bands. A detailed description of dynamically changing the setting of preferred bands is provided in the following.

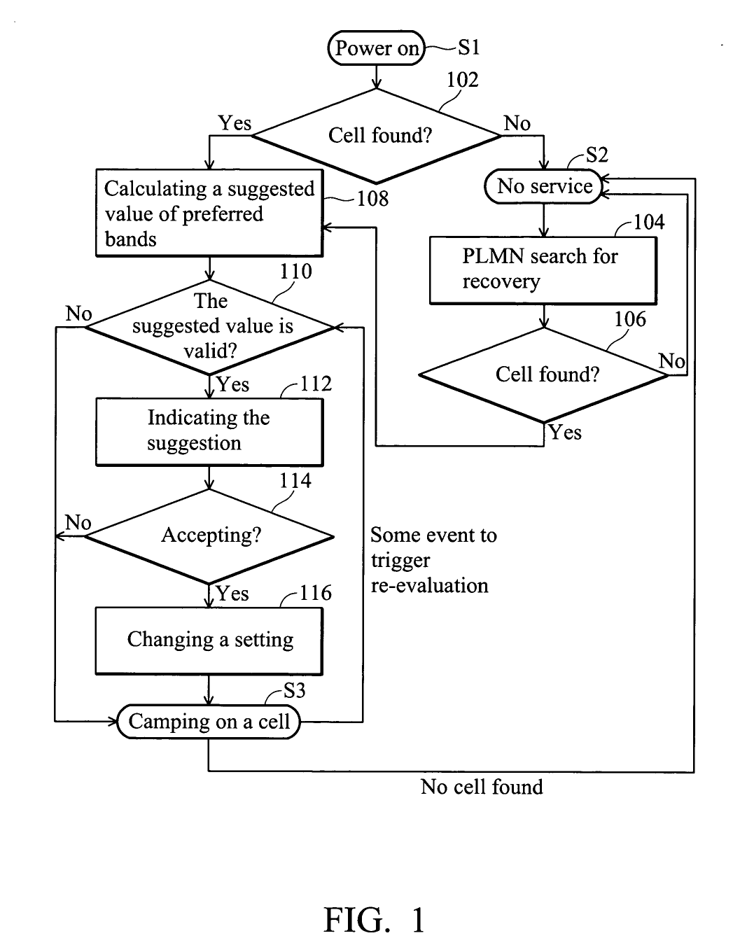

Please refer to FIG. 1. FIG. 1 is a flowchart illustrating a band selection method according to a first embodiment of the invention. After power on (state S1), the mobile station either camps on a cell (state S3) or enters a no service state (state S2). If no cell is found (e.g. in a tunnel) after power on (step 102), the mobile station enters the no service state (state S2) and then performs a PLMN (public land mobile network) search for recovery from lack of coverage (step 104). If a cell is found again (e.g. out of the tunnel) after the PLMN search (step 106), the mobile station calculates a suggested value of preferred bands (step 108); otherwise the mobile station stays in the no service state (state S2). A detailed description of calculating the suggested value will be described later. If the suggested value of preferred bands is valid (step 110), a suggestion will appear through a user interface, e.g. a man-machine interface (MMI), instructing the user to change the setting of preferred bands (step 112). For example, if the original setting of preferred bands is band 900 and the found cell is in the band 900, but the found cell is in a country utilizing dual band (e.g. band 900 and band 1800), the suggestion will instruct the user to change the setting of preferred bands from band 900 to dual band. If the user accepts the suggestion (step 114), the mobile station will change the setting of preferred bands (step 116) and then camp on the cell according to the updated setting of preferred bands (state S3); otherwise, the mobile station camps on the cell directly according to the original setting (state S3). Additionally, after camping on a cell (state S3), if the mobile station cannot find the cell again (e.g. when entering a tunnel), the mobile station will enter the no service state (state S2) and repeatedly try to find a cell. If some event (e.g. enter a new country) is triggered after camping on the cell, the mobile station will re-calculate the suggested value of preferred bands (step 110).

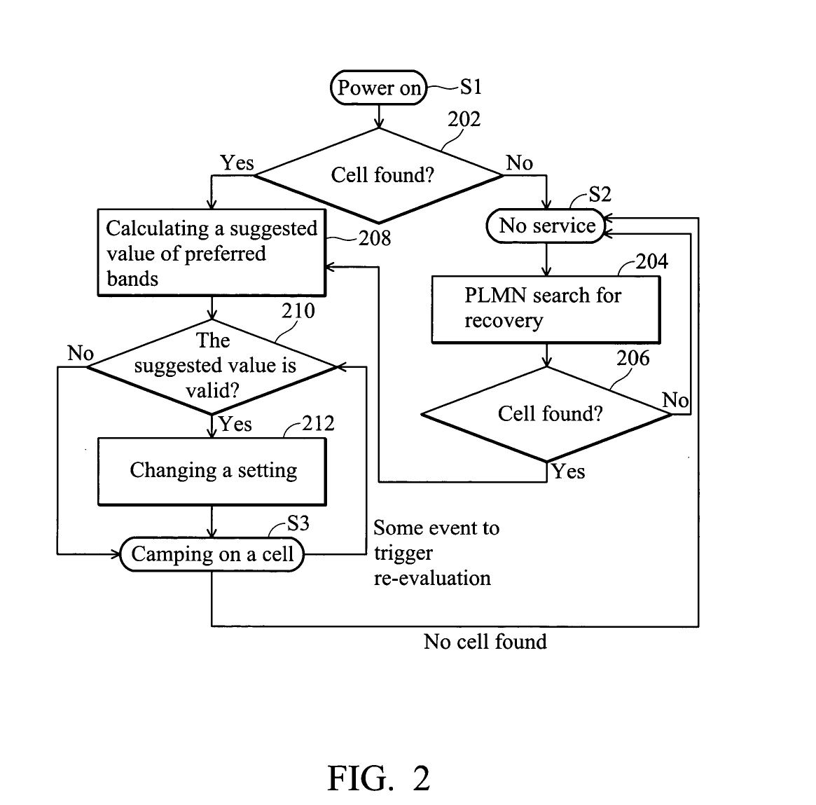

Please refer to FIG. 2. FIG. 2 is a flowchart illustrating a band selection method according to a second embodiment of the invention. In the second embodiment, the band selection method is more intelligent in that it automatically changes the setting of preferred bands rather than asking the user as in the first embodiment. For example, if the original setting of preferred bands is band 900, but the found cell is in a country utilizing dual band (e.g. band 900 and band 1800), the mobile station will automatically change the setting of preferred bands from band 900 to dual band (step 212).

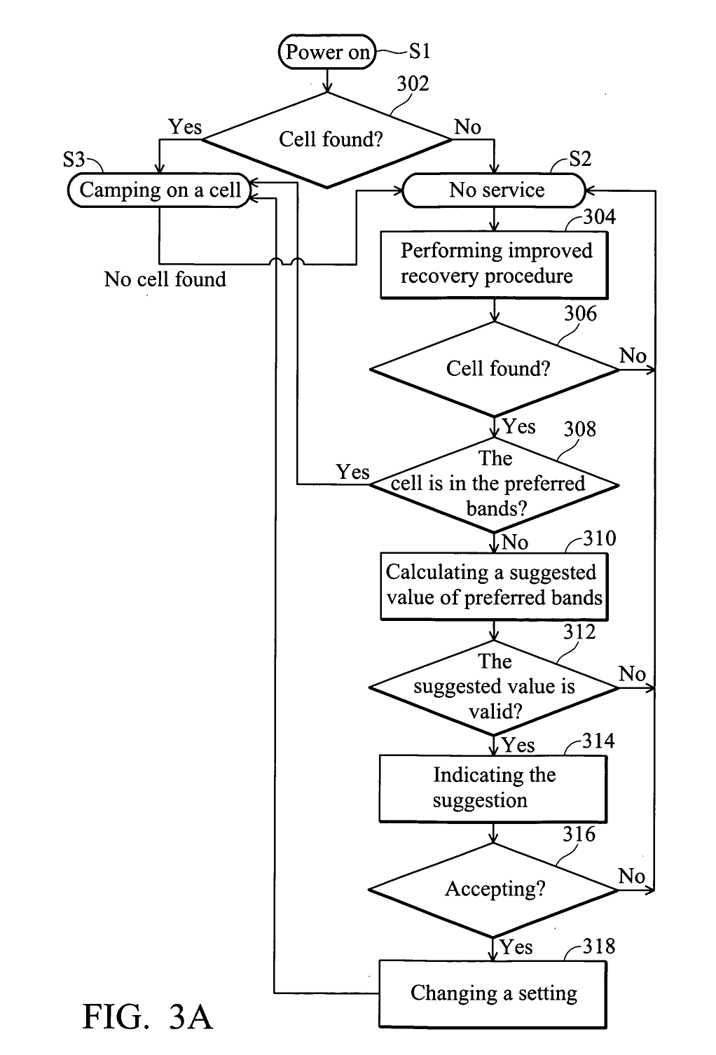

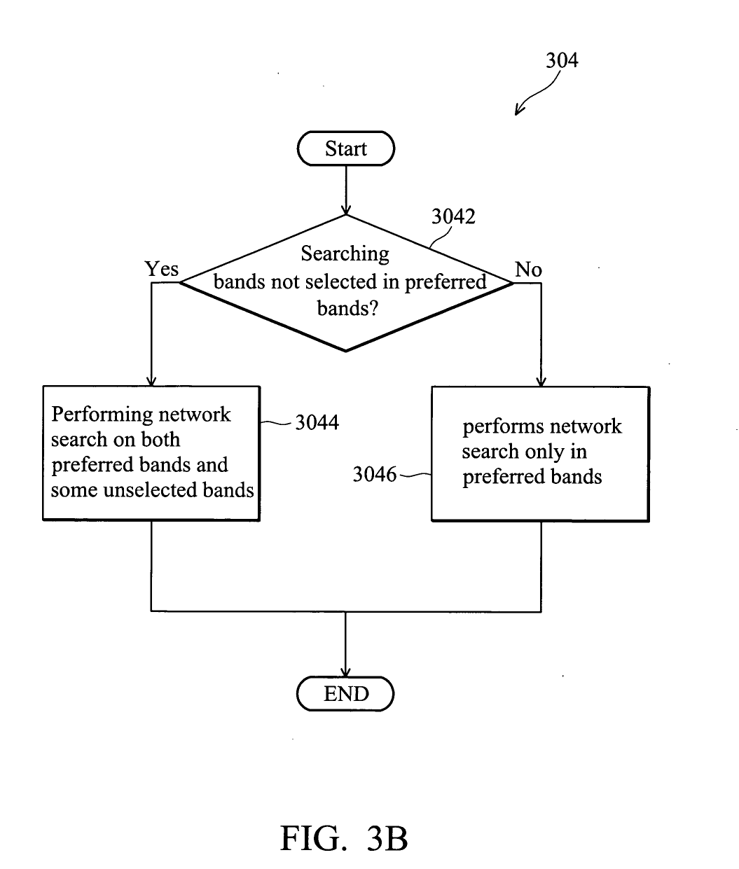

Please refer to FIG. 3A. FIG. 3A is a flowchart illustrating a band selection method according to a third embodiment of the invention. After power on (state S1), the mobile station either camps on a cell (state S3) or enters a no service state (state S2). If no cell is found (e.g. in a tunnel) after power on (step 302), the mobile station enters the no service state (state S2) and then performs an improved recovery procedure that is different from the PLMN search in previous embodiments for recovery from lack of coverage (step 304). The improved recovery procedure may search all the supported bands. Compared with the PLMN search in the first and second embodiment, the improved recovery procedure in the third embodiment may search unselected bands, which are not included in the preferred bands, but the PLMN search does not. A detailed description of the improved recovery procedure will be described later (in FIG. 3B). If a cell is found again after the improved recovery procedure (step 306), the mobile station will determine whether the found cell is in the preferred bands (step 308). For example, assume that the original setting of preferred bands is band 900. If the found cell is in band 1900 (found in the improved recovery procedure when searching unselected bands), it proceeds to step 310 to give a suggested value of preferred bands. Otherwise, if the found cell is also in the preferred bands (band 900), the mobile station camps on the cell according to the original setting of preferred bands (state S3). In step 310, the mobile station calculates the suggested value of preferred bands. If the suggested value is valid (e.g. the calculated preferred bands are meaningful) (yes in step 312), the method will proceed to step 314; otherwise, the mobile station will return to the no service state again (state S2). For example, assume that the suggested value of preferred bands is valid (yes in step 312) and equal to dual bands 850 and 1900, then the corresponding suggestion will be shown in the user interface (step 314). If the user does not accept the suggestion to update the setting of preferred bands (no in step 316), the mobile station will enter the no service state (state S2) since no cell can be found in the original setting of preferred bands (the found cell is in band 1900, but the original setting of preferred bands is band 900). Otherwise (yes in step 316), the setting of preferred bands is changed to bands 850 and 1900 (step 318).

Please refer to FIG. 3B. FIG. 3B is a flowchart illustrating the improved recovery procedure in order to find all of supported bands, comprising preferred bands and unselected bands (which are not included in the preferred bands), being utilized in the mobile communication system. The mobile station determines whether it is necessary to search bands not selected in the preferred bands (step 3042). If no, the mobile station performs a network search in preferred bands (the same as the PLMN search for recovery in the first and second embodiments). If yes, the mobile station performs a network search on the preferred bands and unselected bands (step 3044). For example, the mobile station can utilize a counter to count a predetermined value of times to determine whether it is necessary to search unselected bands. Assume that the predetermined value of times is equal to three; then the mobile station searches on the preferred bands and the unselected bands every three times (3, 6, 9, 12 . . . ) and searches in the preferred bands in other times not equal to the multiple of three (1, 2, 4, 5, 7, 8, 10, 11 . . . ). The predetermined value of times can be initially set to be a small value so as to search unselected bands frequently for reducing the network search failure, and also can be set to be an increased value so as to search unselected bands rarely for saving power consumption.

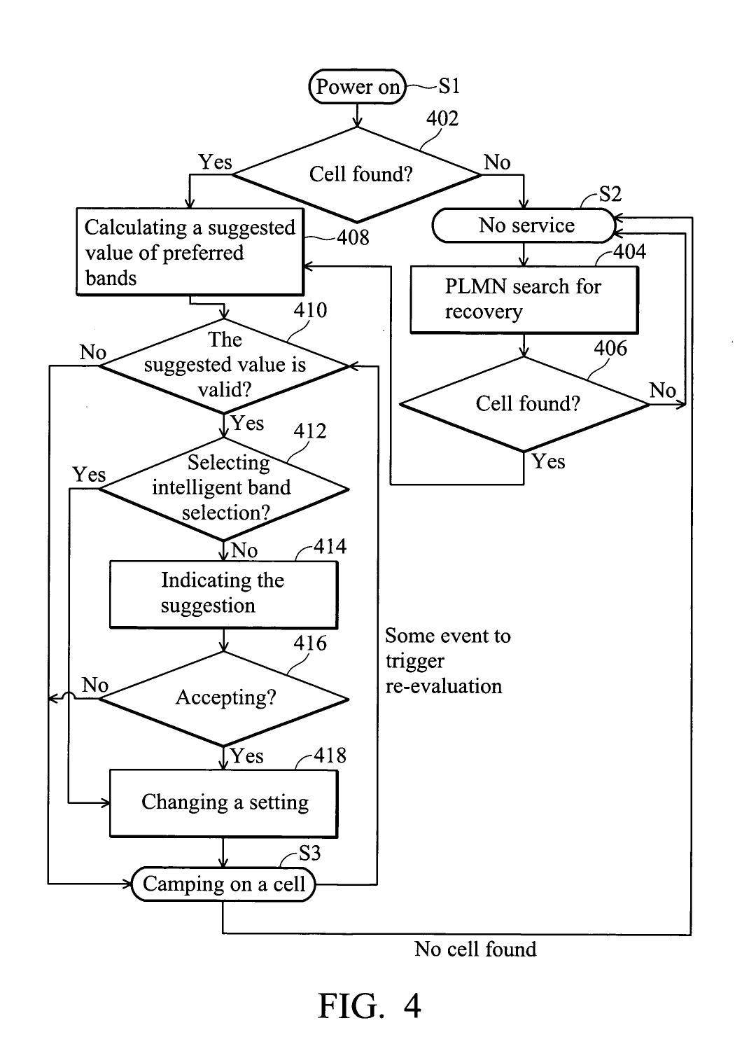

Please refer to FIG. 4. FIG. 4 is a flowchart illustrating a band selection method according to a fourth embodiment of the invention. Compared with the first and second embodiments, in the fourth embodiment, an extra option is provided for the user of the mobile station to choose to either manually or automatically change the setting of preferred bands. If an automatic method of changing the setting of preferred bands is chosen (yes in step 412), the setting of preferred bands will be changed directly without asking for the allowance from the user (step 418). Otherwise, if a manual method of changing the setting of preferred bands is chosen (no in step 412), a suggestion will be shown on the user interface to ask for user's allowance of changing the setting of preferred bands (step 414).

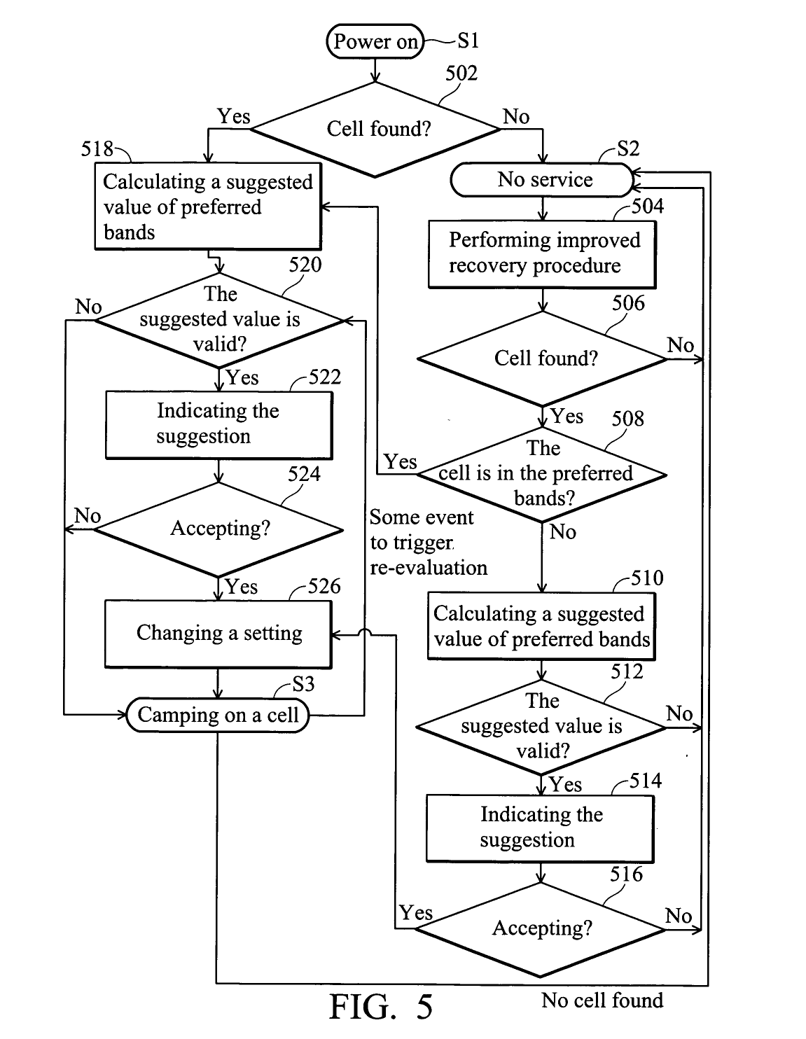

Please refer to FIG. 5. FIG. 5 is a flowchart illustrating a band selection method according to a fifth embodiment of the invention. After power on (state S1), the mobile station either camps on a cell (state S3) or enters the no service state (state S2). If no cell is found (e.g. in a tunnel) after power on (step 502), the mobile station enters the no service state (state S2) and then performs an improved recovery procedure that is different from the PLMN search in the first and second embodiments for recovery from lack of coverage (step 504). The improved recovery procedure may search all the supported bands. Since the improved recovery procedure has been described in FIG. 3B, further discussion is omitted for brevity. If a cell is found again after the improved recovery procedure (step 506), the mobile station determines whether the found cell is in the preferred bands (step 508). For example, if the original setting of preferred bands is band 900, but the found cell is in band 1900, this method proceeds to step 510 to give a suggested value of preferred bands; otherwise, it proceeds to step 518 to give another suggested value of preferred bands. A detailed description of giving two different suggested values of preferred bands is provided in the following. In the step 510, the mobile station calculates the suggested value of preferred bands. If the suggested value is valid (e.g. the calculated preferred bands are meaningful) (yes in step 512), the method will proceed to step 514; otherwise, the mobile station will return to the no service state again (state S2). For example, assume that the suggested value of preferred bands is valid (yes in step 512) and equal to dual bands 850 and 1900 (assume that the original setting of preferred bands is band 900, but the found cell is in band 1900), then the corresponding suggestion will be shown in the user interface (step 514). If the user does not accept the suggestion to update the setting of preferred bands (no in step 516), the mobile station enters the no service state (state S2) since no cell can be found in the original setting of preferred bands (found cell is in band 1900, but the original setting of preferred bands is band 900). On the other hand, in the step 518, assume that the original setting of preferred bands is band 900 and the found cell is also in band 900. Although the original setting of preferred bands is good enough to make the mobile station to camp on the cell, the user interface still gives a suggested value of preferred bands to optimize the setting of preferred bands. If the suggested value is valid (yes in step 520), the corresponding suggestion will be shown in the user interface (step 522); otherwise (no in step 520), the mobile station camps on the cell according to the original setting (state S3). For example, in the condition of valid suggested value, if the found cell is in a country utilizing dual bands 900 and 1800, the user interface then suggests the user to change the setting of preferred bands from band 900 to bands 900 and 1800 (step 522). If the user does not accept the suggestion (no in step 524), the mobile station still can camp on the cell in band 900 (state S3), but once the user moves to another cell utilizing band 1800, the mobile station cannot camp of the current cell and enter the no service state (S2) since the setting of preferred bands does not include band 1800.

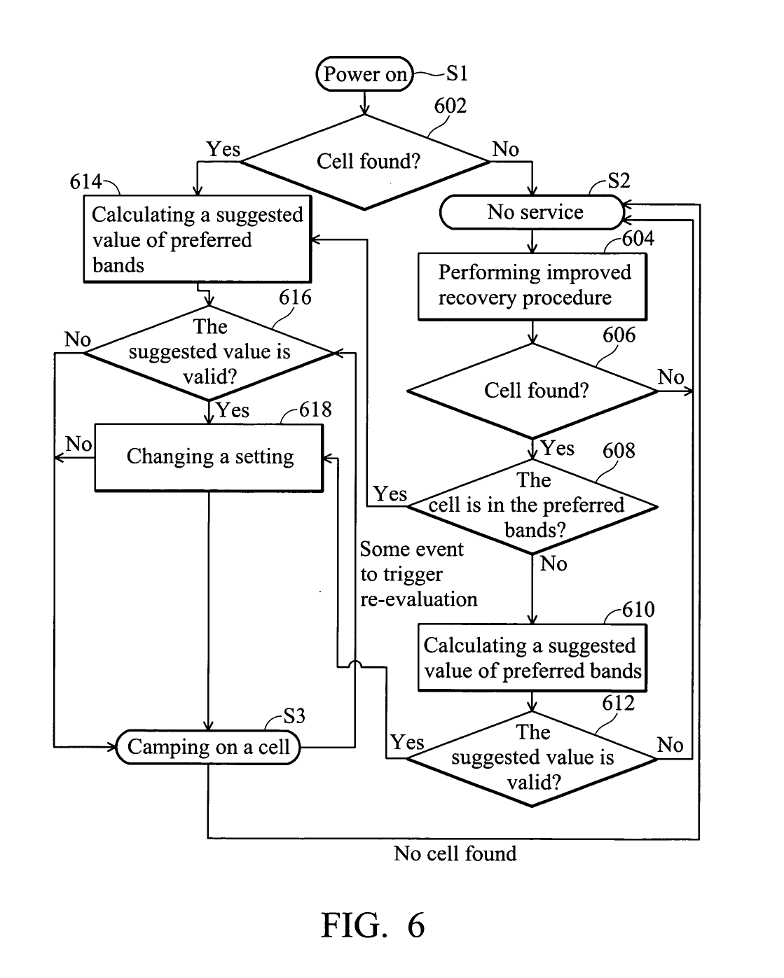

Please refer to FIG. 6. FIG. 6 is a flowchart illustrating a band selection method according to a sixth embodiment of the invention. In the sixth embodiment, the band selection method is more intelligent in that it automatically changes the setting of preferred bands rather than asking the user as in the fifth embodiment. Both the fifth and sixth embodiments calculate the suggested value of preferred bands in two different situations (steps 510 and 518, steps 610 and 614), but the suggested value is accepted directly to automatically change the setting of preferred bands (step 618) in the sixth embodiment rather than asking the allowance from the user (steps 516 and 524) in the fifth embodiment.

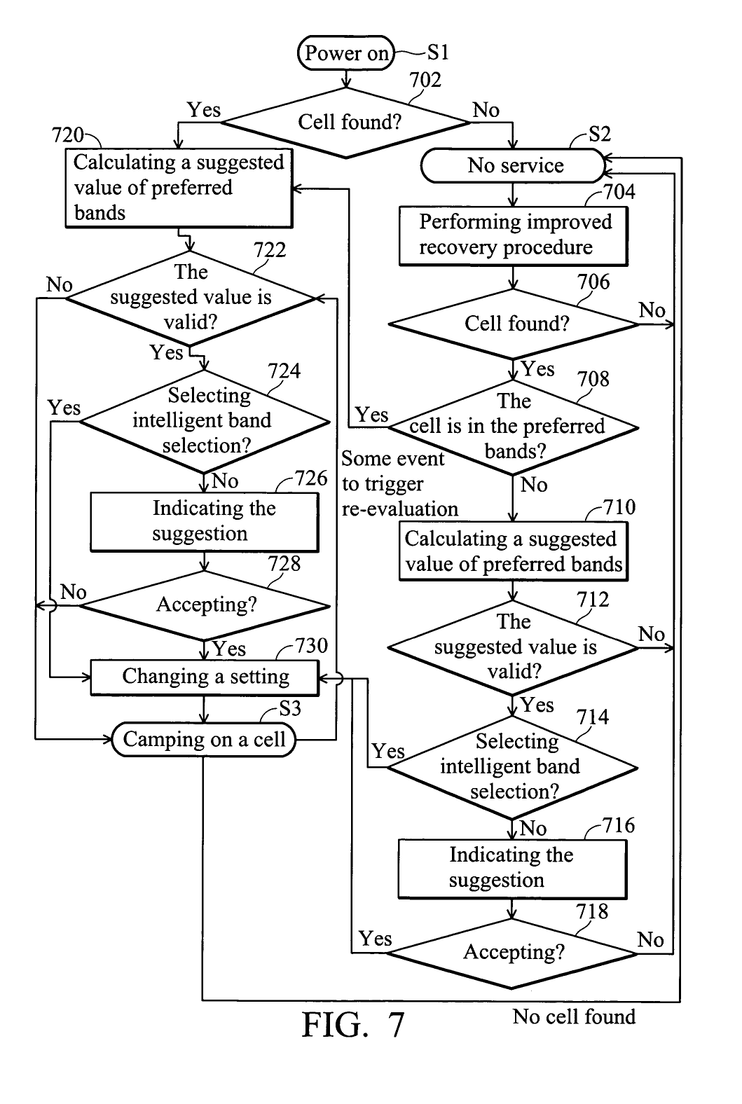

Please refer to FIG. 7. FIG. 7 is a flowchart illustrating a band selection method according to a seventh embodiment of the invention. Compared with the fifth and sixth embodiments, in the seventh embodiment, an extra option is provided for the user of the mobile station to choose to either manually or automatically change the setting of preferred bands. If an automatic method of changing the setting of preferred bands is chosen in the extra option (yes in steps 714 and 724), the setting of preferred bands will be changed directly without asking the user (step 730). Otherwise, if a manual method of changing the setting of preferred bands is chosen (no in steps 714 and 724), a suggestion will be shown on the user interface to ask the user for allowance of changing the setting of preferred bands (steps 716 and 726). Finally, a detailed description of calculating suggested value is provided in the following.

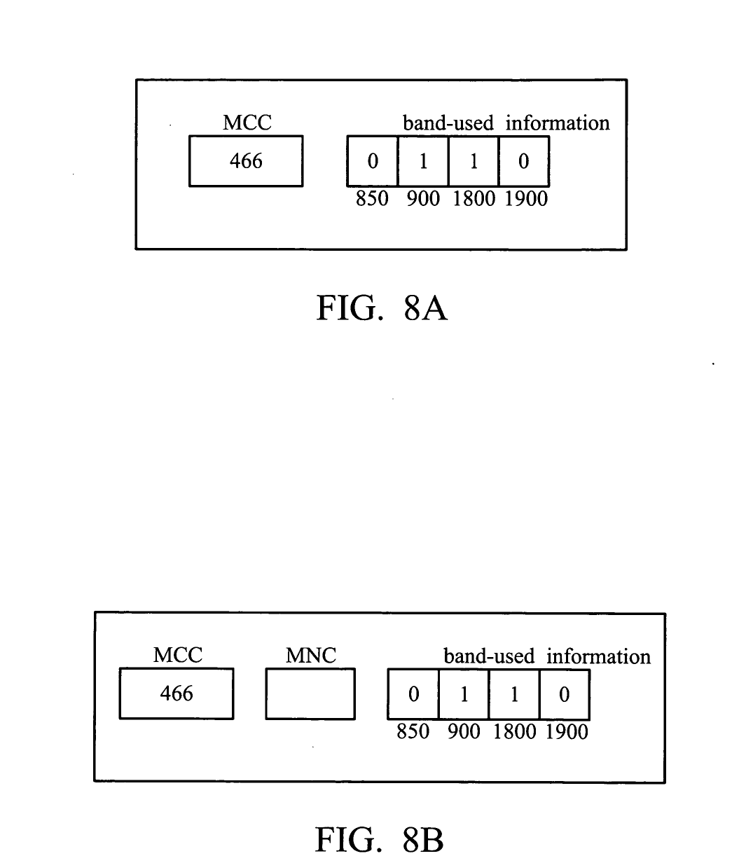

The suggested value may be calculated according to the band-used information stored in the mobile station. There are various ways to maintain the band-used information. For example, the mobile station can utilize a look-up table comprising a plurality of items to store the band-used information. Please refer to FIG. 8A and FIG. 8B. FIG. 8A and FIG. 8B show different item formats in the look-up table. In FIG. 8A, each item comprises an MCC (Mobile Country Code) column (3 digits) and a band-used information column; in FIG. 8B, each item comprises an MCC column, an MNC column (2 digits), and a band-used information column. For example, if the item stores Taiwan's band-information, the MCC column will be 466 (Taiwan's country identification code) and the band-used information column will be 0110 in binary to store information of the usage of dual band 900 and 1800 in Taiwan (see FIG. 8A). After a cell is found, the mobile station can also obtain the country code based on system information broadcasted by the found cell, and calculate a suggested value according to a corresponding item (whose value in the MCC column is the same as the country identification code corresponding to the found cell) in the look-up table. For example, if the country code corresponding to the found cell is found to be 466, a suggested value of preferred bands comprising band 900 and band 1800 is given after searching the look-up table. In FIG. 8B, the MNC column is further added in each item to store the network identification code. There are various methods for maintaining the look-up table. A detailed description of look-up table maintenance is omitted for the sake of brevity.

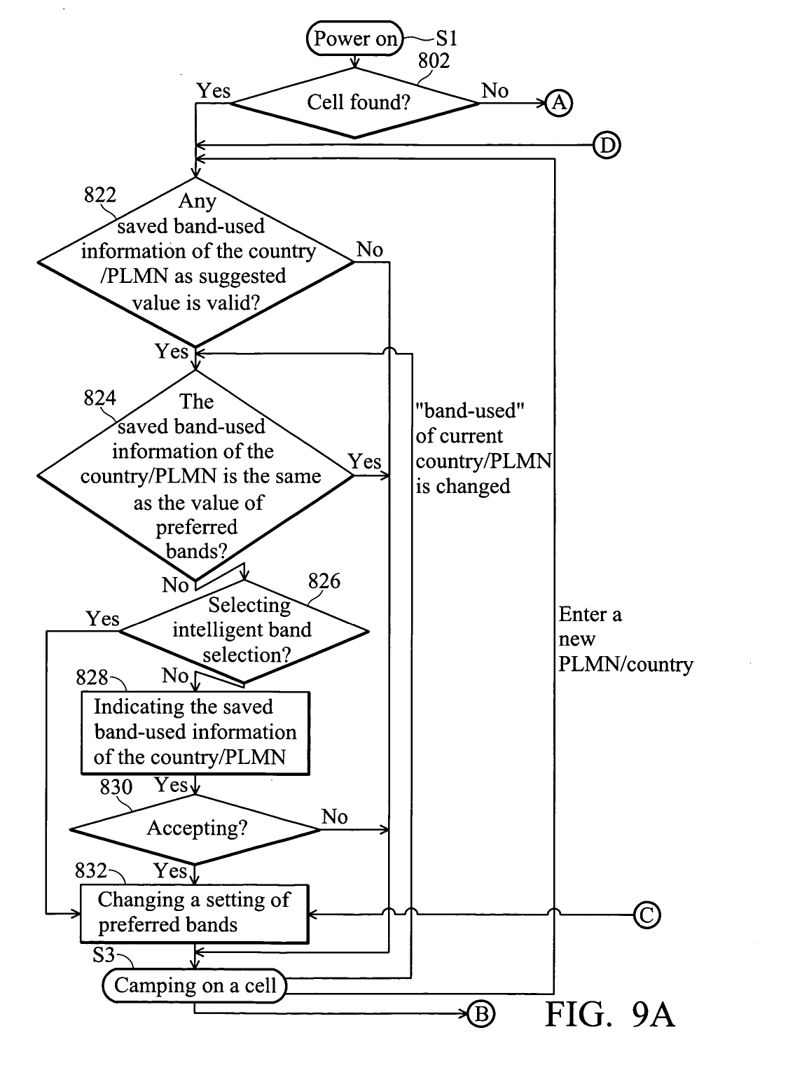

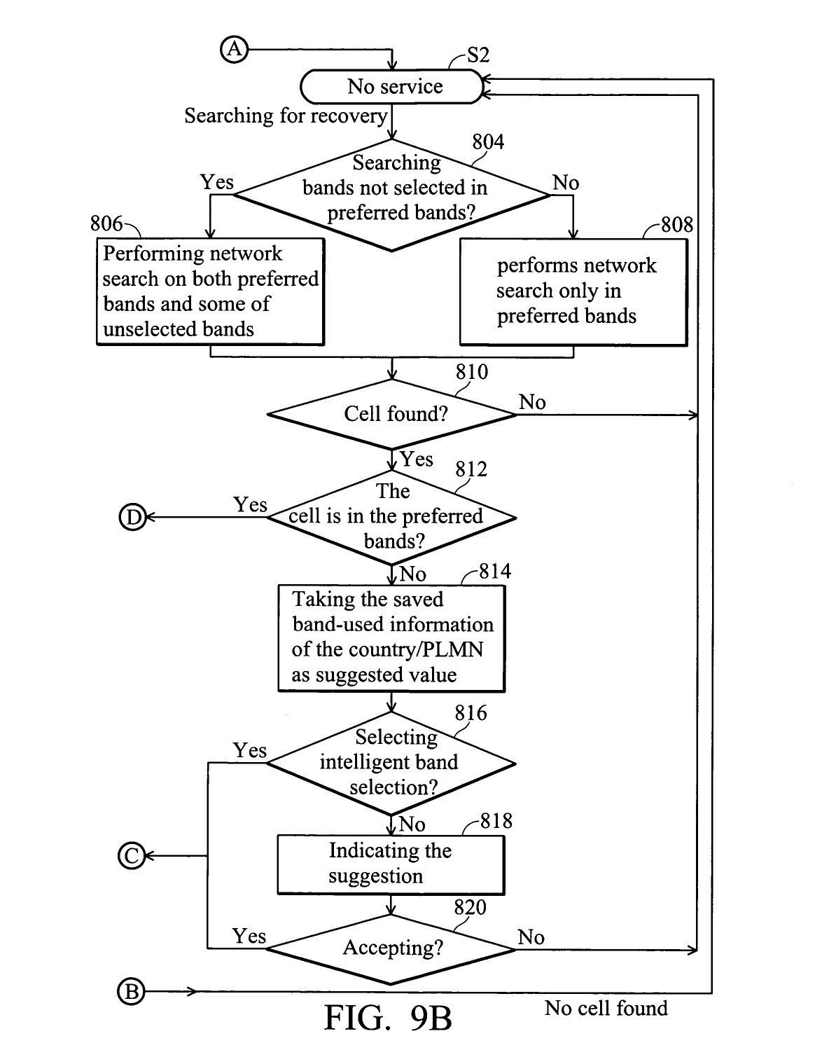

Please refer to FIG. 9. FIG. 9 is a flowchart illustrating a band selection method according to an eighth embodiment of the invention. Compared with the seventh embodiment, the band selection method of the eighth embodiment is further described with how to utilize the band-used information to give the suggested value of preferred bands (steps 814, 822, 824, and 828). Additionally, each previous embodiment can be modified to further describe with how to utilize the band-used information. Here only the seventh embodiment is given as an example.

Compared with the related art, the band selection method of the invention may consume less power since the carrier search is performed on optimised preferred bands and unavailable bands may not be searched. Additionally, unexpected failure may seldom occur since the setting of preferred bands can be changed dynamically to fit the current network environment. Even if the user initially makes an incorrect or unsuitable setting of preferred bands, the band selection method can still find an optimised setting of preferred bands by utilizing the improved recovery procedure.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A band selection method utilized in a mobile station, said mobile station operates in a plurality of supported bands, said mobile station is in a mobile communication system, said mobile communication system comprises a plurality of cells, comprising:
calculating a suggested value of band selection to match a current environmental state of the mobile communication system;
changing a setting of band selection according to the suggested value of band selection; and
camping on a cell according to the setting of band selection.

2. The method of claim 1, wherein the suggested value of band selection is the suggested value of preferred bands, and the setting of band selection is the setting of preferred bands; wherein the preferred bands are bands selected by a user.

3. The method of claim 2, wherein the step of changing the setting of preferred bands further comprises:
indicating a suggestion to ask allowance from a user; and
changing the setting of preferred bands if the allowance is granted;
wherein the suggestion is indicated through a user interface of the mobile station.

4. The method of claim 2, wherein the step of changing the setting of preferred bands further comprises:
changing the setting of preferred bands automatically without asking any allowance.

5. The method of claim 2, wherein the step of changing the setting of preferred bands further comprises:
providing an option in a user interface of the mobile station to determine whether to ask allowance or not before changing the setting of preferred bands.

6. The method of claim 2 further comprising:
performing an recovery procedure to find unselected bands in use of the mobile communication system; and
adding the unselected bands to the suggested value of preferred bands;
wherein the unselected bands are bands not in the preferred bands but bands in the supported bands.

7. The method of claim 6, wherein the step of adding the unselected bands further comprises:
indicating a suggestion to ask an allowance from user; and
adding the unselected bands to the suggested value of preferred bands if the allowance is obtained;
wherein the suggestion is indicated through a user interface of the mobile station.

8. The method of claim 6, wherein the step of adding the unselected bands further comprises:
adding the unselected bands automatically without asking any allowance.

9. The method of claim 6, wherein the step of adding the unselected bands further comprises:
providing an option in a user interface of the mobile station to determine whether to ask allowance or not before adding the unselected bands.

10. The method of claim 2, wherein the step of calculating the suggested value further comprises:
calculating the suggested value according to band-used information of different countries and/or operators.

11. The method of claim 10, wherein a look-up table comprising a plurality of items is utilized to maintain the band-used information of different countries and/or operators.

12. The method of claim 11, wherein each item of the look-up table comprises an MCC column and a band-used information column; the MCC column stores information of country identification code, and the band-used information column stores the band-used information corresponding to the country identification code.

13. The method of claim 11, wherein each item of the look-up table comprises an MCC column, an MNC column, and a band-used information column; the MCC column stores information of country identification code, the MNC column stores information of network identification code, and the band-used information column stores the band-used information corresponding to the country and network identification codes.

14. A mobile station in a mobile communication system, said mobile station operates in a plurality of supported bands, said mobile communication system comprises a plurality of cells, comprising:
means for calculating a suggested value of band selection to match to a current environment state of the mobile communication system;
means for changing a setting of band selection according to the suggested value of band selection; and
means for camping on a cell according to the setting of band selection.

15. The mobile station of claim 14, wherein the suggested value of band selection is the suggested value of preferred bands, and the setting of band selection is the setting of preferred bands; wherein the preferred bands are bands selected by a user.

16. The mobile station of claim 15 further comprising:
means for indicating a suggestion to ask allowance from a user before changing the setting of preferred bands;
wherein the suggestion is indicated through a user interface of the mobile station.

17. The mobile station of claim 15 further comprising:
means for providing an option in a user interface of the mobile station to determine whether to ask allowance or not before changing the setting of preferred bands.

18. The mobile station of claim 15 further comprising:
means for performing an recovery procedure to find unselected bands in use of the mobile communication system; and
means for adding the unselected bands to the suggested value of preferred bands;
wherein the unselected bands are bands not in the preferred bands but bands in the supported bands.

19. The mobile station of claim 15 further comprising a look-up table having a plurality of items for maintaining band-used information of different countries and/or operators, and the suggested value is calculated accordingly.

20. The mobile station of claim 19, wherein each item of the look-up table comprises an MCC column and a band-used information column; the MCC column stores information of country identification code, and the band-used information column stores the band-used information corresponding to the country identification code.
